(19) United States
(12) Patent Application Publication
(10) Pub. No.: US 2003/0216674 A1
(43) Pub. Date: Nov. 20, 2003

(54) Massaging machine

(75) Inventors: Akitoshi Miki, Ibaraki (JP); Kentaro Mori, Nara (JP)

Correspondence Address: BEYER WEAVER & THOMAS LLP, P.O. BOX 778, BERKELEY, CA, 94704-0778, US

(73) Assignee: OMRON Corporation

(21) Appl. No.: 10/437,877

(22) Filed: May 13, 2003

(30) Foreign Application Priority Data
May 14, 2002 (JP) 2002-177760

(51) Int. Cl. A61H 15/00

(52) U.S. Cl. 601/99; 601/100; 601/102; 601/103

(57) ABSTRACT

A massaging machine includes massaging balls, a pair of ball supporting members supporting the massaging balls, two rotary shafts such as a massaging shaft and a pounding shaft for driving the ball supporting members so as to cause the massaging balls to undergo two different treatment actions such as massaging and pounding, a single shaft holder for holding these two rotary shafts parallel to each other, connecting mechanisms connected to both end parts of these two shafts for connecting and operating together the two shafts and the ball supporting members, motors for operating these two shafts independently and motion communicating mechanisms for communicating driving power of the motors to the two rotary shafts. The shaft holder is disposed entirely between the pair of ball supporting means and includes parts that support the motors.

### BACKGROUND OF THE INVENTION

This invention relates to a massaging machine. Many massaging machines of the type provided with a mechanism for carrying out therapy operations such as massaging and pounding have been known. They can be categorized roughly into a type of using only one driving source such as a motor to operate both a massaging mechanism and a pounding mechanism and another type of using one drive source for each of these two mechanisms. Massaging machines of the latter type are capable of operating both the massaging and pounding mechanisms at the same time and are hence advantageous in that a variety of therapy operations can be performed. On the other hand, they are disadvantageous because an increased number of motors are necessary and hence the massaging mechanism becomes bulky. An increased number of power supply lines will be needed to these motors and their arrangement also becomes complicated. In the case of massaging machines built like a chair, furthermore, a large massaging mechanism is adapted to move vertically upward and downward inside the backrest portion of the chair structure and hence a large portion of the space inside the backrest portion is used for this vertical motion of the bulky massaging mechanism. If it is attempted to position not only the operating mechanism for this vertical motion of the massaging mechanism but also the control circuit for this and other mechanism inside the backrest portion of the chair structure, the backrest portion itself becomes unreasonably bulky and this makes the entire massaging machine difficult to handle.

Japanese Patent Publications Tokkai 2000-116741 and 2000-350756 have disclosed massaging machines of this type having a motor for each of the pounding and massaging mechanisms each with an attempt to reduce the size of the massaging mechanism and to simplify its structure. The former discloses a structure comprising a mutually parallel pair of upper and lower shafts supported by a frame and connected by two arms, rotating means for these shafts having an upper gear motor for the upper shaft and a lower gear motor for the lower shaft and these gear motors each being directly connected to the corresponding one of the shafts. The latter discloses a structure wherein a massaging unit having a massaging motor and a pounding unit having a pounding motor are mounted to a base plate such that the position of each will not interfere with that of the other and the a massaging output shaft and a pounding output shaft are connected by arms for driving massaging balls.

With the former, the massaging mechanism must be assembled carefully such that its two shafts remain parallel and it is difficult to remove the motors, say, for a repair. Moreover, components for assembling together the two units are required. Since each of the two units is structured so as to drive its shaft through a worm mechanism by means of a gear motor, furthermore, each gear motor must be positioned near the center of the corresponding shaft and perpendicularly to its axial direction. Thus, these two units must be assembled so as to maintain a positional relationship between the two gear motors such that they will not interfere with each other.

With the latter, too, the assembly must be effected carefully such that its two shafts remain parallel to each other. In addition, its two units are disposed on the left-hand and right-hand sides of the backrest portion in order to prevent their interference and it cannot be said that space is effectively utilized. Since their motors are disposed away from each other, furthermore, the wiring for supplying power to them becomes complicated.

### SUMMARY OF THE INVENTION

It is therefore an object of this invention to provide a compact massaging machine.

A massaging machine embodying this invention may be characterized not only as comprising massaging balls, a pair of ball supporting means for supporting the massaging balls, two rotary shafts (such as a massaging shaft and a pounding shaft) for driving the ball supporting means and thereby causing the massaging balls to undergo two different treatment actions (such as massaging and pounding), a single shaft holder for holding these two rotary shafts parallel to each other, connecting means connected to both end parts of these two shafts for connecting and operating together the two shafts and the ball supporting means, motors for operating these two shafts independently, and motion communicating means for communicating driving power of the motors to the two rotary shafts but also wherein the shaft holder is disposed entirely between this pair of ball supporting means and includes motor supports that support the motors. With main mechanisms such as the motors gathered together so as to be supported by the same component that also supports the two rotary shafts used for the treatment operations such as massaging and pounding, the massaging machine embodying this invention can be made compact.

According to a preferred embodiment of the invention, at least one of the motion communicating means is disposed inside the single shaft holder and this motion communicating means disposed inside the shaft holder and the motor of which the driving power is communicated thereby are disposed opposite each other with respect to the rotary shaft driven therethrough. The two motors may preferably be disposed not only between the two rotary shafts but also approximately perpendicular to each other. It is further preferable that these motors be supported by the shaft holder so as to be removably attachable from a direction facing the back of the user and another direction opposite thereto. This makes the motors easier to assemble and easier to maintain.

A massaging machine of this invention may also be characterized wherein at least one of the motors be supported by the single shaft holder approximately parallel and adjacent to said rotary shafts. It is further preferable that the two motors be supported by the single shaft holder so as to be each removably attachable from a direction of a different one of said two rotary shafts.

It is also preferable that the aforementioned massaging balls, ball supporting means, rotary shafts, shaft holder, connecting means, motors and motion communicating means together comprise a treatment unit that is movable with respect to the user. With the treatment thus made mobile with respect to the user, it is preferable to provide the massaging machine with position detectors for detecting angular positions of the two rotary shafts and limit sensors for detecting limit positions of the treatment unit. If the shaft holder includes support members for supporting these position detectors and limit sensors, the work of wiring these detectors and sensors becomes simplified.

The massaging machine may further comprise two guide members for guiding the treatment unit and a control circuit for controlling the massaging machine. It is further preferable that these guide members be disposed on mutually opposite external sides of lines extended along these two rotary shafts and that this control circuit be disposed further outside of one of these guide members with respect to the two rotary shafts because the treatment unit, the guide members and the control circuit can be distributed by making use of available space effectively and the massaging machine as a whole can be made significantly more compact.

### BRIEF DESCRIPTION OF THE DRAWINGS

FIG. 1 is a schematic front view of a massaging machine embodying this invention.

FIG. 2 is a schematic side view of the massaging machine of FIG. 1.

FIGS. 3A, 3B, 3C, 3D, 3E and 3F, together referred to as FIG. 3, are views of vertically mobile treatment unit of the massaging machine of FIG. 1 from six mutually perpendicular directions.

FIG. 4 is a front view of the treatment unit of FIG. 3.

FIG. 5 is a back view of the treatment unit of FIG. 3.

FIG. 6 is a diagonal front view of the treatment unit of FIG. 3.

FIG. 7 is a diagonal back view of the treatment unit of FIG. 3.

FIG. 8 is a front view of the treatment part of the massaging machine of FIG. 1.

FIG. 9 is a left-hand side view of the treatment part of FIG. 8.

FIG. 10 is a back view of the treatment part of FIG. 9.

FIG. 11 is a right-hand side view of the treatment part of FIG. 8.

FIG. 12 is a diagonal front view of the treatment part of FIG. 8.

FIG. 13 is a diagonal right-hand back view of the treatment part of FIG. 8.

FIG. 14 is a diagonal sectional view of FIG. 13.

FIG. 15 is a diagonal left-hand back view of the treatment part of FIG. 8.

FIG. 16 is another diagonal sectional view of FIG. 13.

FIG. 17 is portion of FIG. 11 shown enlarged.

FIG. 18 is a portion of FIG. 15 shown enlarged.

FIGS. 19 and 20 show the positional relationship between a stopper receiver of an arm supporter and a stopper of a ball supporting arm on the massaging machine of FIG. 1

FIG. 21A shows the arm supporter of FIG. 19 supporting massaging balls, FIG. 21B is its sectional view taken along line 21B-21B and FIG. 21C is its another sectional view taken along line 21C-21C.

FIG. 22A shows the contour of a sandwiching member of an arm supporter and FIG. 22B shows the contact surface between the sandwiching members of an arm supporter.

FIGS. 23A, 23B and 23C, together referred to as FIG. 23, are respectively a front view, a side view and a back view of the detector for the rotary motion of the massaging shaft.

FIGS. 24A, 24B and 24C, together referred to as FIG. 24, are respectively a front view, a side view and a back view of the big pulley for the pounding operation.

FIG. 25 is a diagonal view of a lower part of the lifting mechanism of the massaging machine of FIG. 1.

FIG. 26 is a flowchart of basic operations of the massaging machine of FIG. 1.

FIG. 27 is a block diagram for the control system of the massaging machine of FIG. 1.

FIG. 28 is a drawing for showing the movements of the massaging balls.

Throughout herein, components which are provided as a pair, one on the left-hand side and the other symmetrically on the right-hand side, are indicated by a same numeral and letters L and R may or may not be attached, depending on the convenience of disclosure and may not be described or explained individually, or both be shown in the drawings.

### DETAILED DESCRIPTION OF THE INVENTION

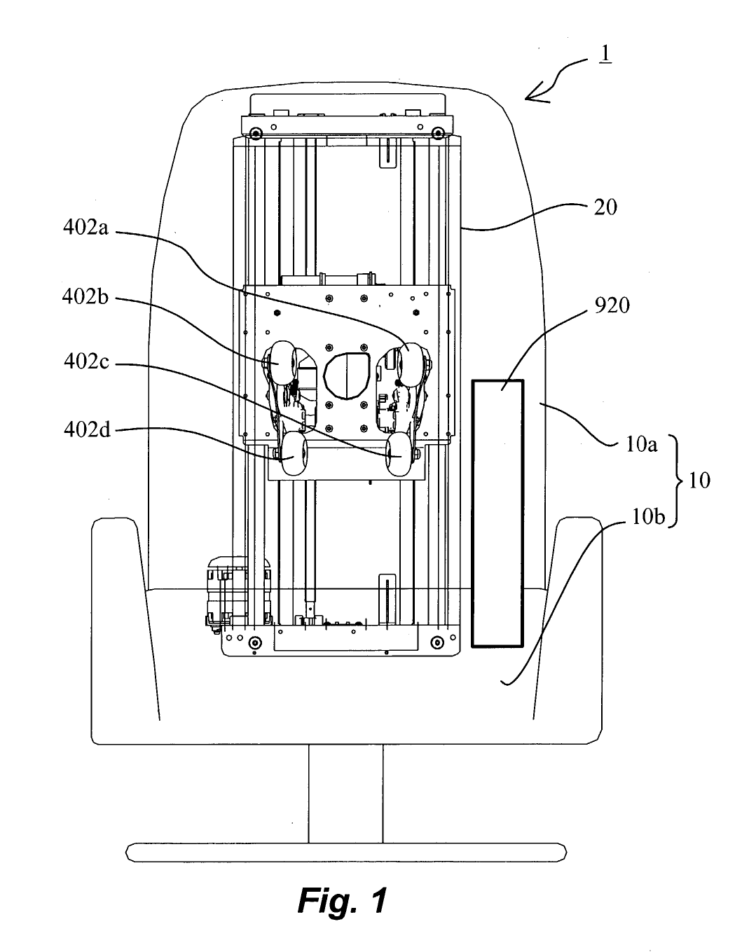

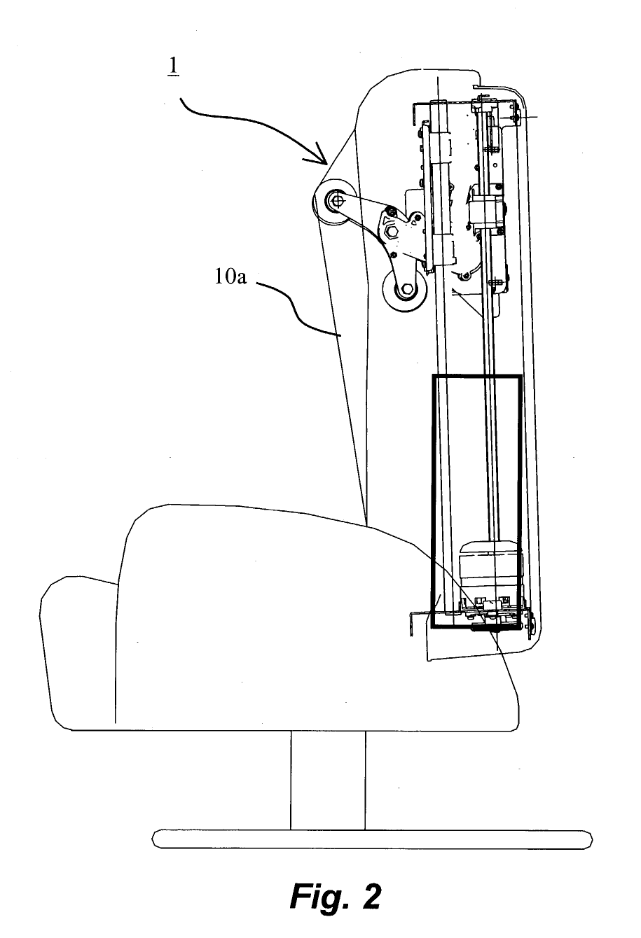

The invention is described by way of an example with reference to figures. FIG. 1 is a front view of a massaging machine 1 embodying this invention and FIG. 2 is its side view. The massaging machine 1, as shown, has a vertically mobile treatment unit 20 contained within a backrest portion 10a of its reclining chair structure 10. The backrest portion 10a is shown in FIGS. 1 and 2 by way of both its external contour and its internal structure. The body of a user is massaged by means of massaging balls 402 (or 402a-d) which protrude from the treatment unit 20 towards the front surface covered with a cover sheet for the backrest portion 10a. The massaging balls consist of an upper pair of left-hand side and right-hand side balls 402a and 402b and a lower pair of left-hand side and right-hand side balls 402c and 402d.

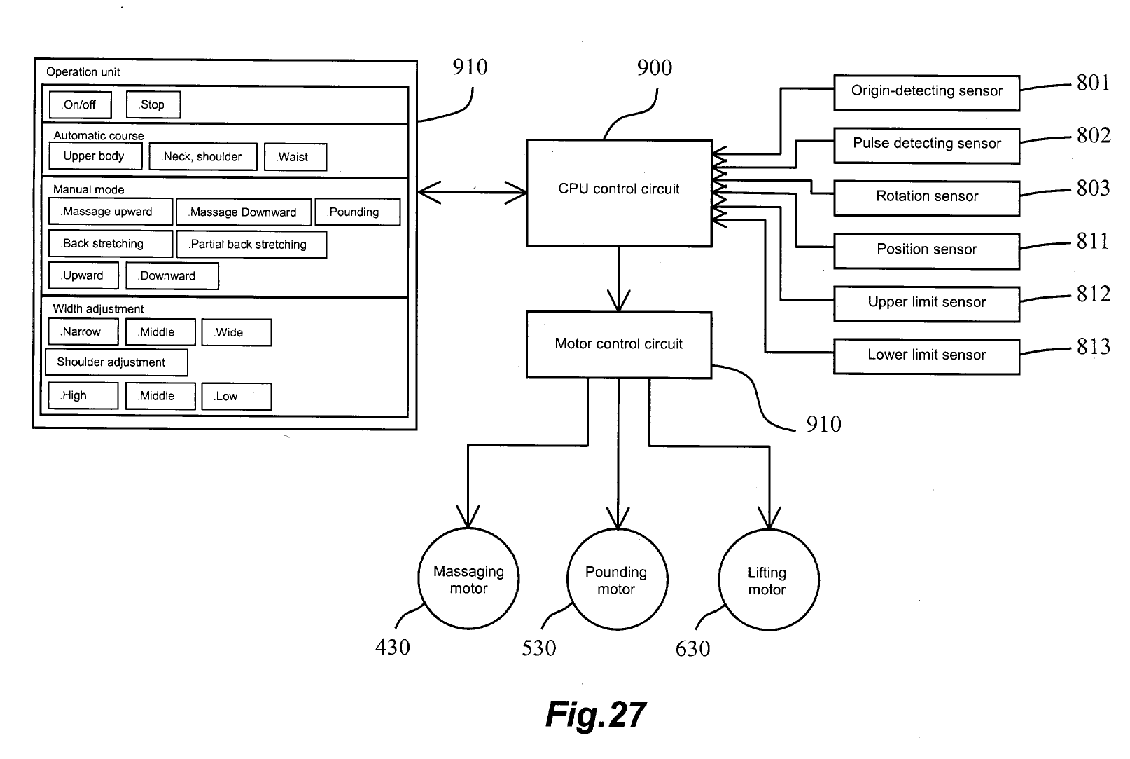

A control box 920 containing a CPU control circuit 900 (shown in FIG. 27) for controlling the operations of the treatment unit 20 and a motor control circuit 901 (shown in FIG. 27) is disposed to one side of the treatment unit 20. The control box 920 is connected to a power source line (not shown) for supplying power from a home power source and an input device 910 (shown in FIG. 27) for a user to operate for making an input operation.

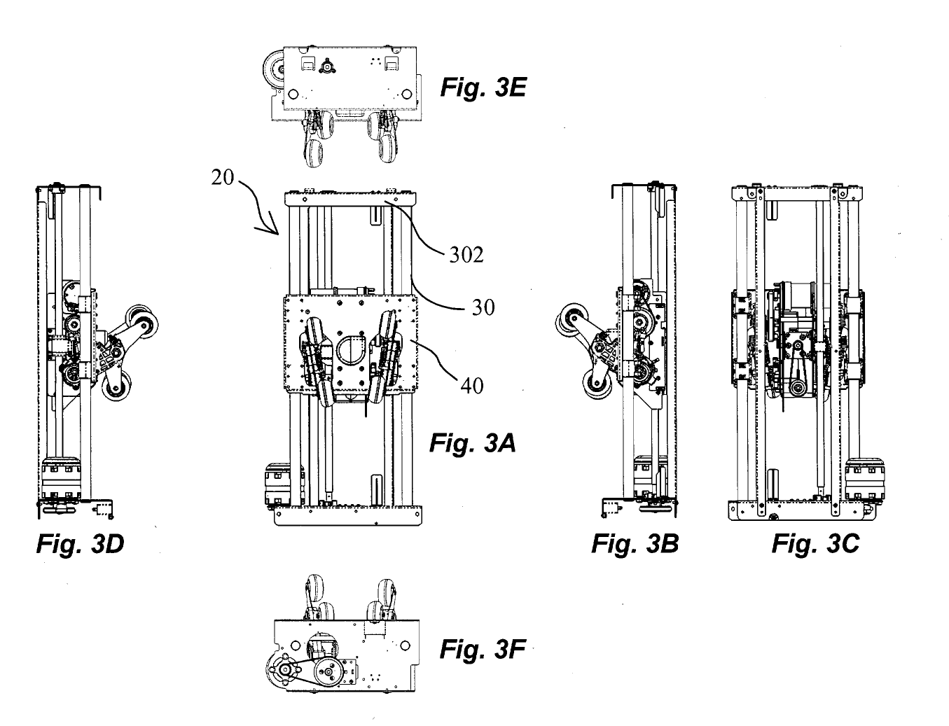

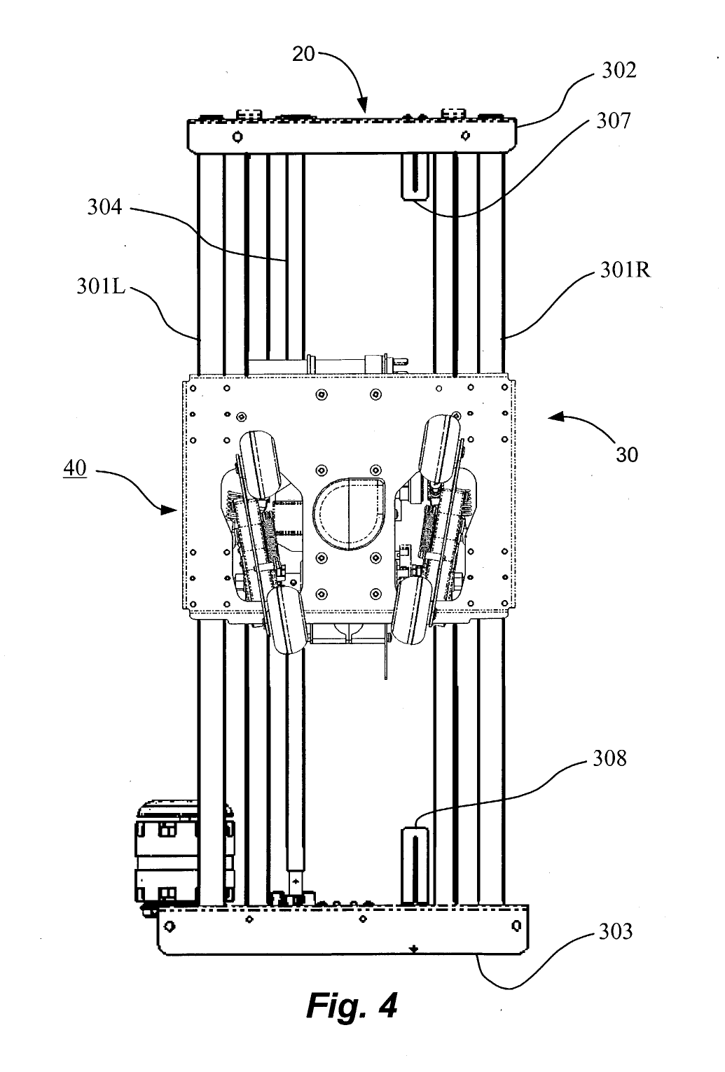

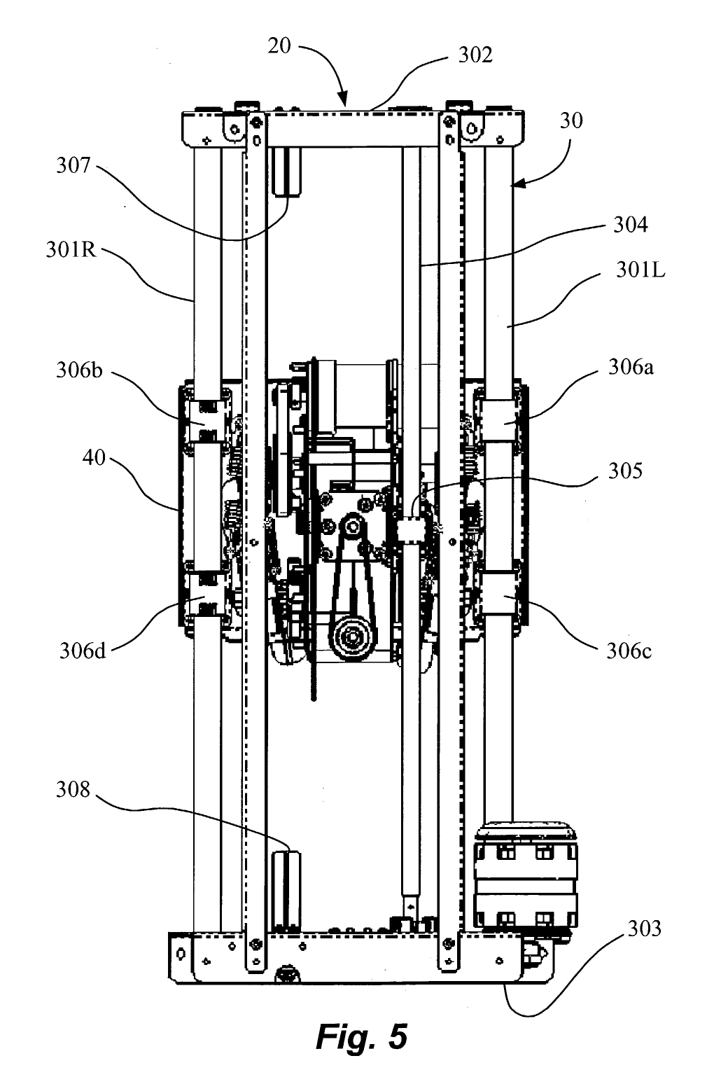

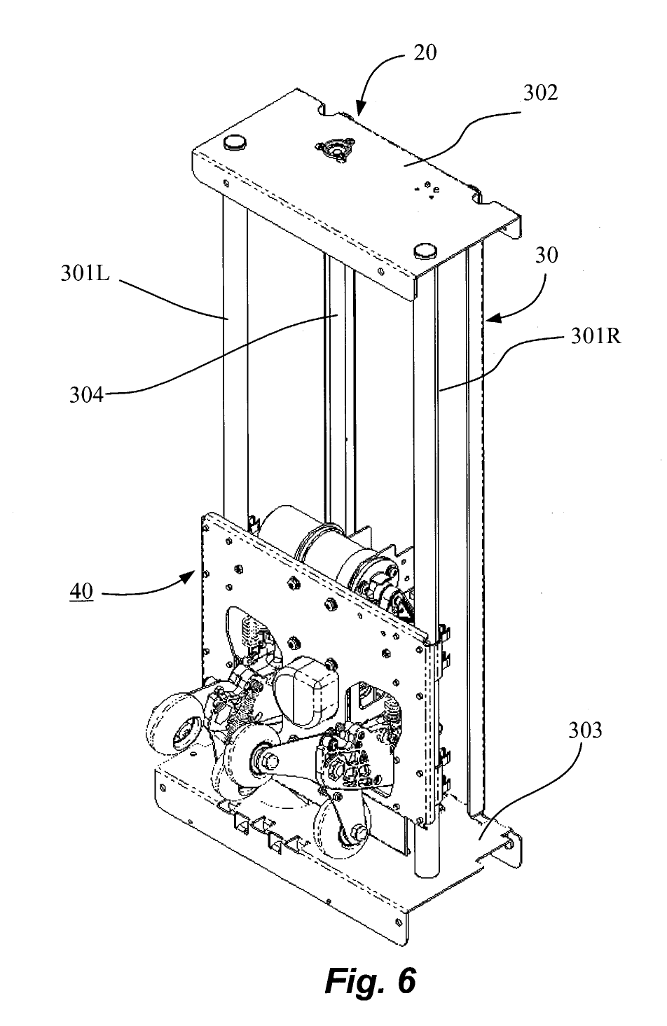

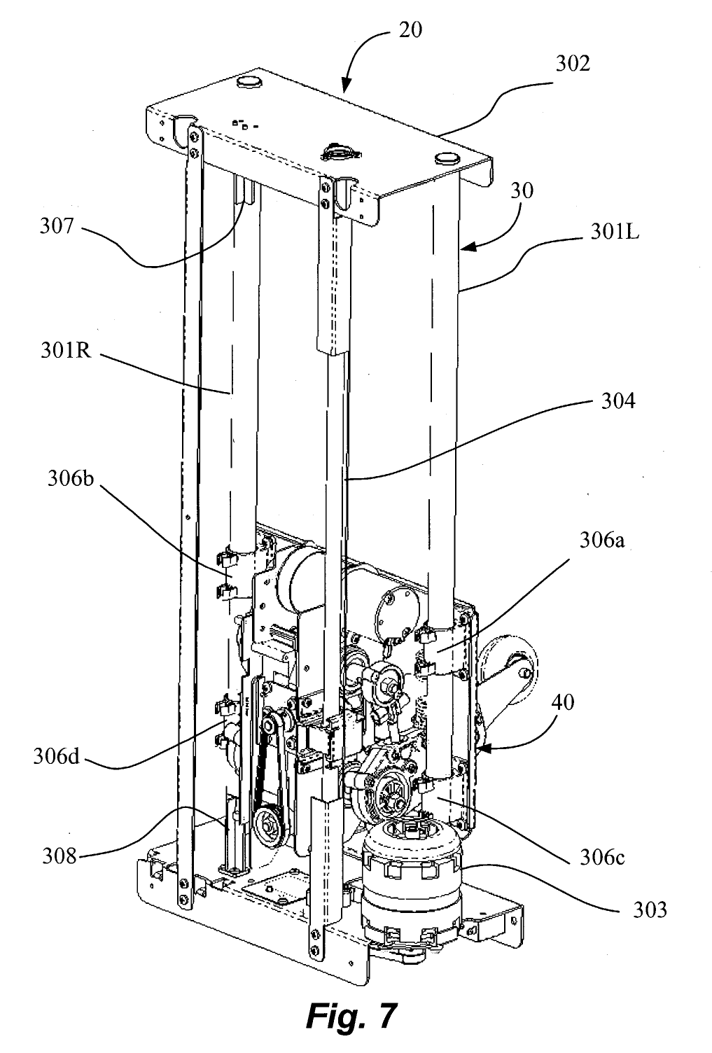

FIGS. 3A, 3B, 3C, 3D, 3E and 3F are respectively a front view, a right-hand side view, a back view, a left-hand side view, a plan view and a bottom view of the vertically mobile treatment unit 20. Its front view and back view are shown more in detail respectively in FIGS. 4 and 5. Its diagonal front view and diagonal back view are shown respectively in FIGS. 6 and 7.

In FIGS. 3-7, numeral 30 generally indicates a lifting mechanism that includes, as shown in FIGS. 4 and 6, a pair of guide pipes (“guiding members”) 301 (or 301R and 301L) which are circular in cross-section and disposed along the backrest portion 10a, a screw shaft 304 disposed between and parallel to the two guide pipes 301R and 301L, and a pair of upper and lower guide pipe holders 302 and 303 which extend perpendicularly to the guide pipes 301R and 301L. The guide pipes 301R and 301L are fixed to the guide pipe holders 302 and 303 but the screw shaft 304 is supported so as to be free to rotate.

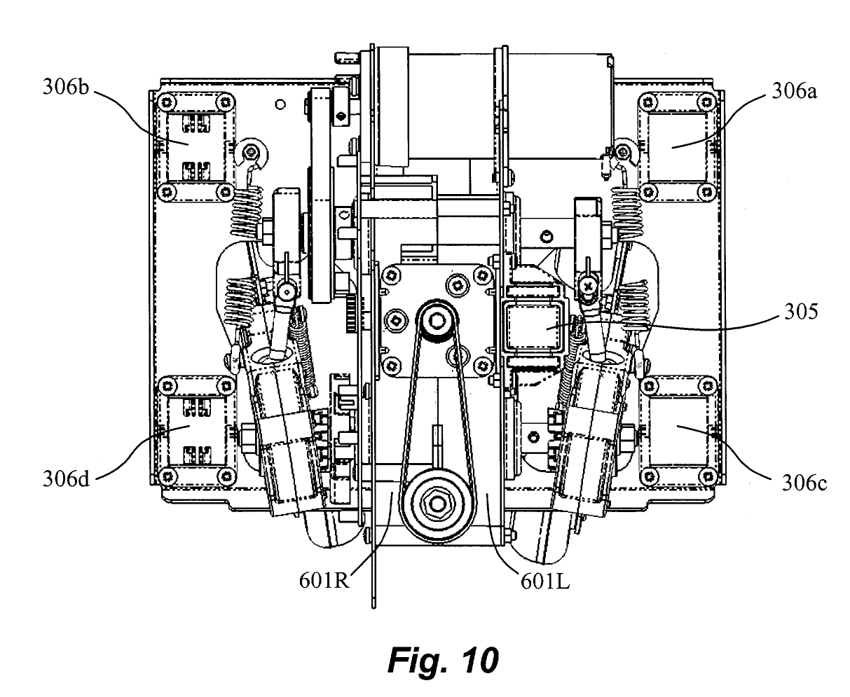

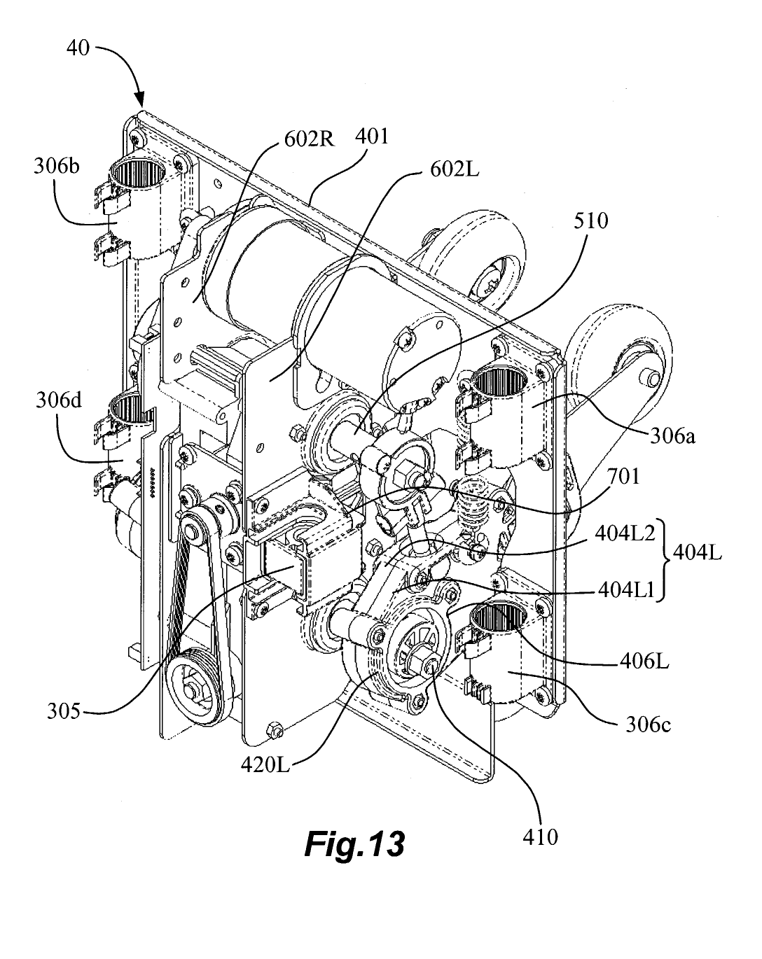

In FIG. 4 et seq., numeral 40 generally indicates a treatment part 40. As shown in FIGS. 5 and 7, the treatment part 40 is supported by the guide pipes 301R and 301L by means of lifting guides 306 (or 306a, 306b, 306c and 306d) which support it so as to be movable in their axial direction and a nut holder 701 for holding a nut 305 which engages the outer periphery of the screw shaft 304. See also FIGS. 10 and 13. As the screw shaft 304 is rotated and the nut 305 is accordingly pushed upward or downward, the nut holder 701 and the treatment part 40 that supports it move upward and downward along the guide pipes 301R and 301L.

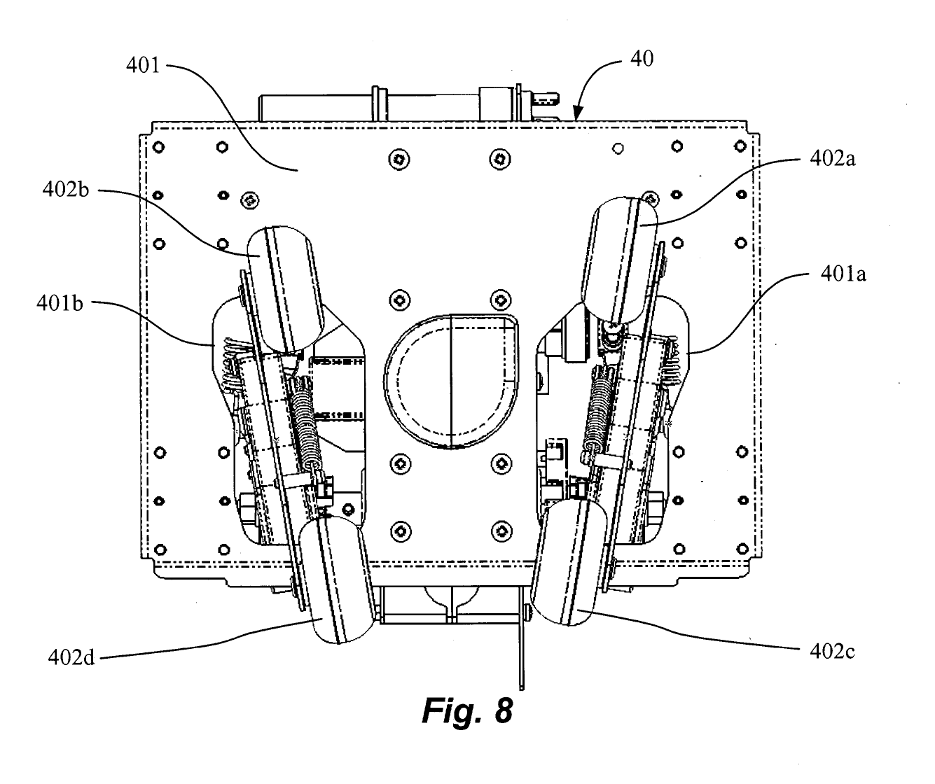

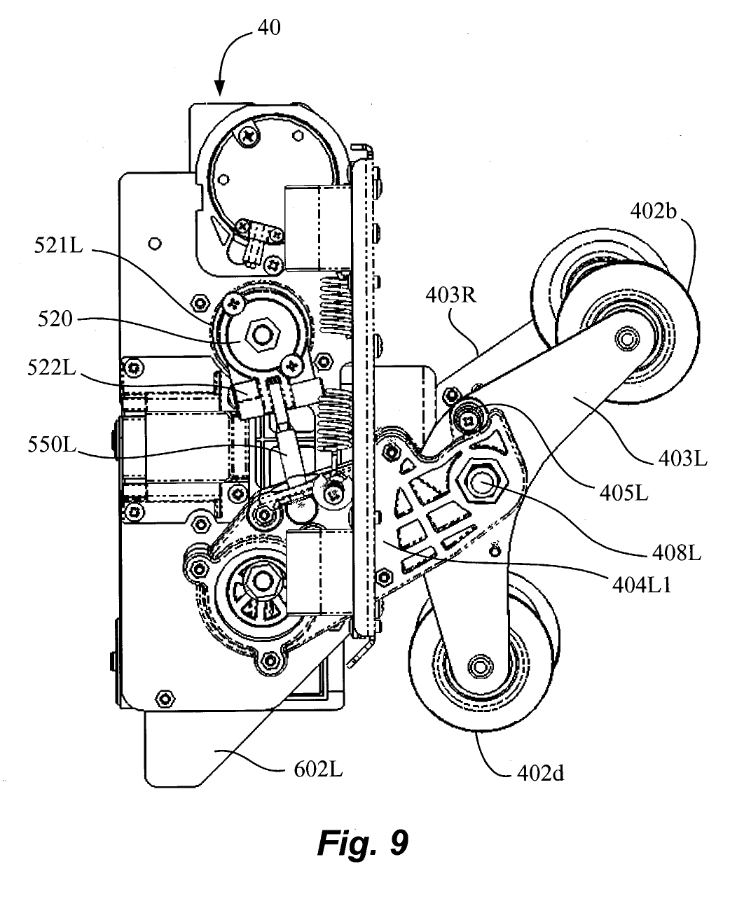

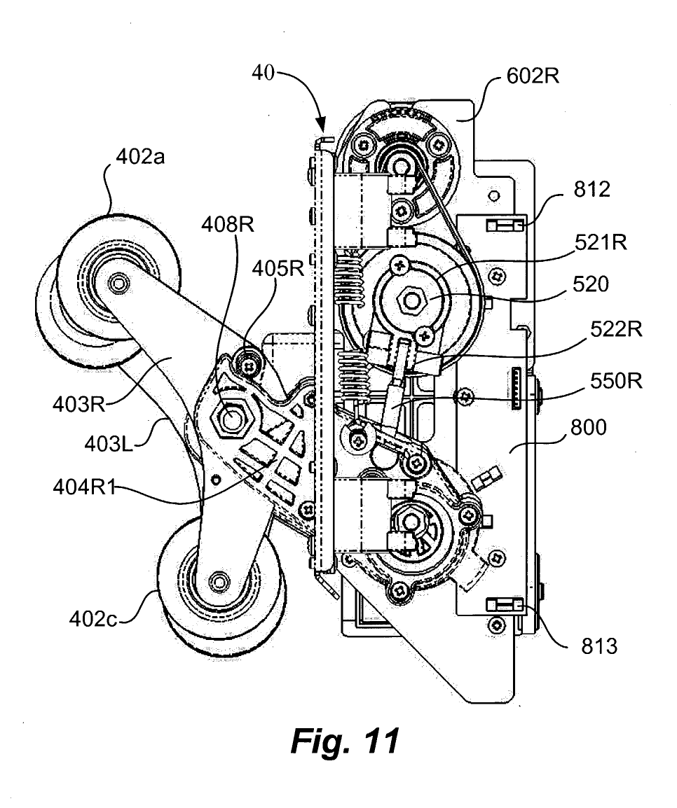

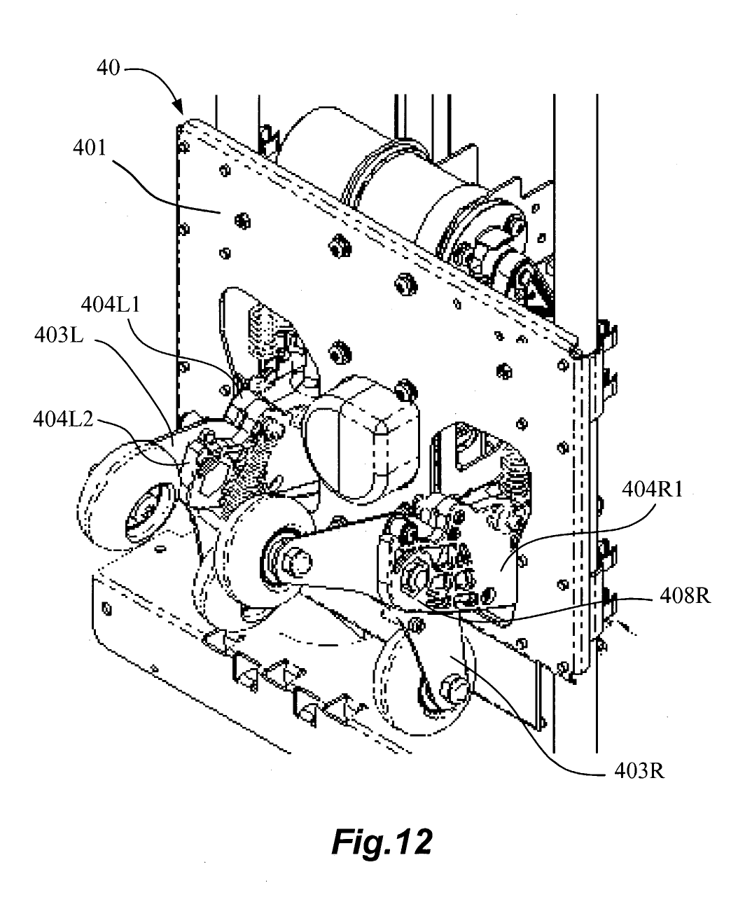

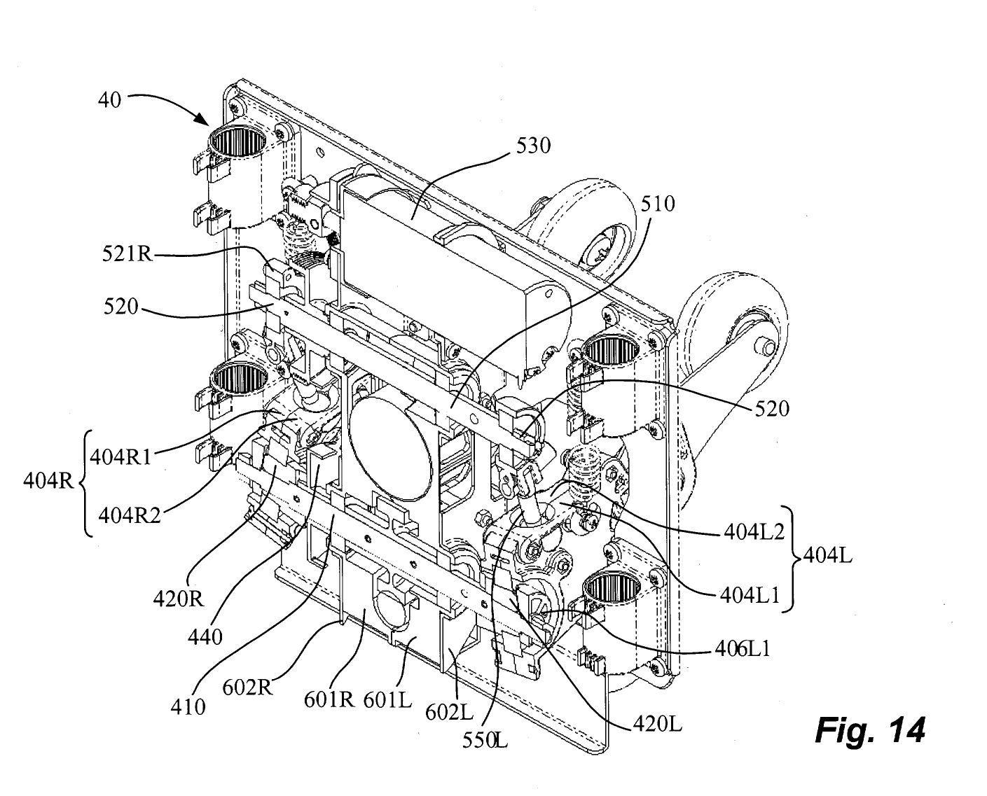

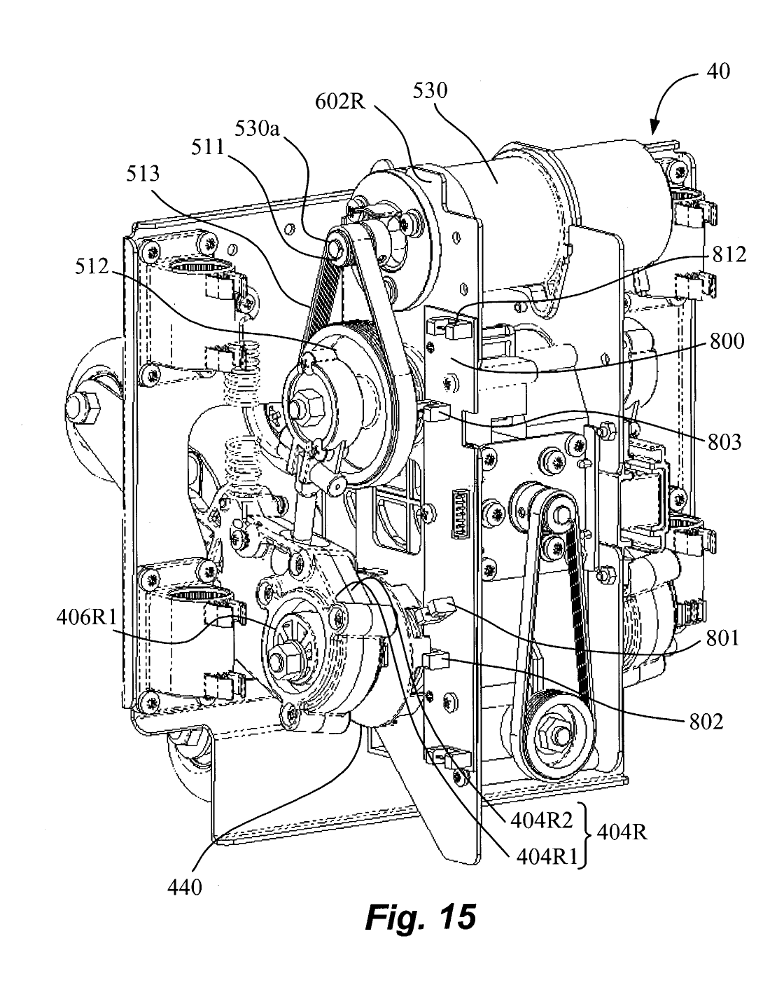

The treatment part 40 will be described next with reference to FIGS. 8-16. The treatment part 40 has its front surface covered with a planar base member 401 provided with approximately rectangular openings 401a and 401b (FIG. 8) near its center for allowing the massaging balls 402a-d to penetrate therethrough. The four massaging balls 402a-d are supported rotatably at the tip parts of approximately V-shaped ball supporting arms 403R and 403L. The base end part of the right-hand side arm 403R is sandwiched between members 404R1 and 404R2 of an arm supporter 404R (FIGS. 14 and 15) and supported rotatably by rotary shaft 408R (FIGS. 11 and 12) and the base end part of the left-hand side arm 403L is sandwiched between members 404L1 and 404L2 of arm supporter 404L (FIGS. 12 and 13) and supported rotatably by rotary shaft 408L (FIG. 9). The supporting arms 403 (that is, 403R and 403L) are provided with stoppers 405 (or 405R and 405L (shown in FIGS. 9 and 11)) for stopping their rotary motion.

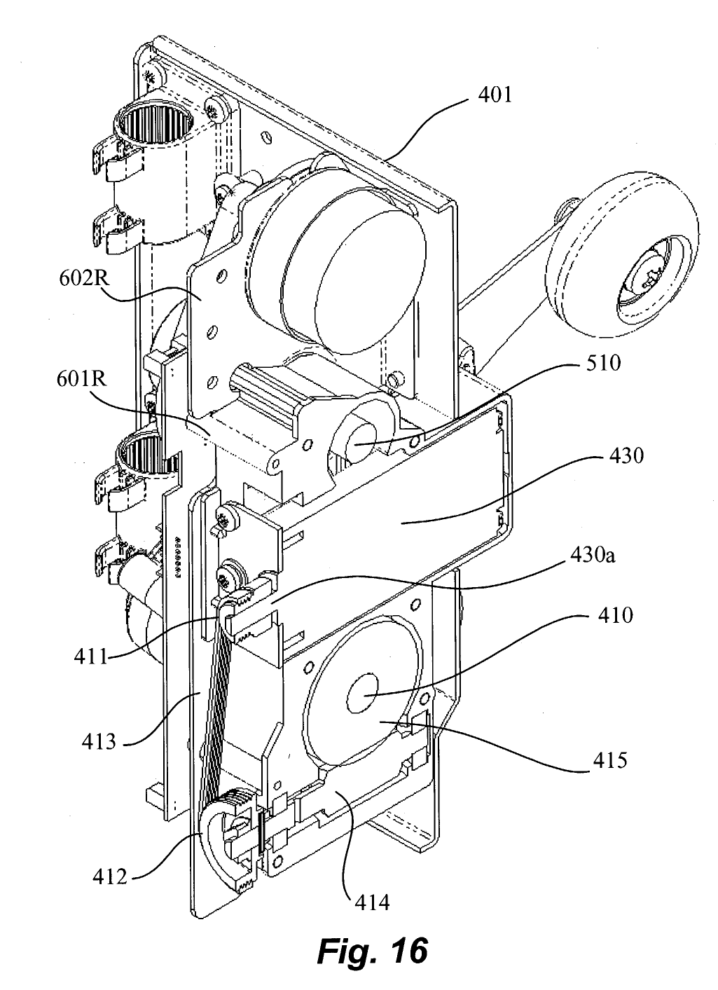

Numeral 410 in FIGS. 13 and 16 represents a rotary shaft for the massaging operation, herein referred to as the “massaging shaft.” Cylindrically shaped sloped sleeves 420 (420R and 420L shown in FIGS. 13 and 14) are affixed to the right-hand and left-hand sides of the massaging shaft 410 so as to be inclined symmetrically with respect to its axial direction. The aforementioned arm supporters 404 (or 404R and 404L), made of a resin material, have base parts 406 (or 406R1, 406R2, 406L1 and 406L2 (only some of which are shown in the figures)) which are rotatably engaged with the outer circumferences of these sleeves 420R and 420L through rotatable bearings (not shown). Link receivers 407 (407R1, 407R2, 407L1 and 407L2 of which only some are shown in the figures) with spherical surface portions are provided between the aforementioned base parts 406 (406R1, 406R2, 406L1 and 406L2). Spherically shaped end portions 551 (551R and 551L not shown) at one end of the links 550 (550R and 550L shown in FIGS. 9 and 11) engage the link receivers 407 (407R1, 407R2, 407L1 and 407L2) and are supported so as to be movable along the spherically shaped link receivers 407.

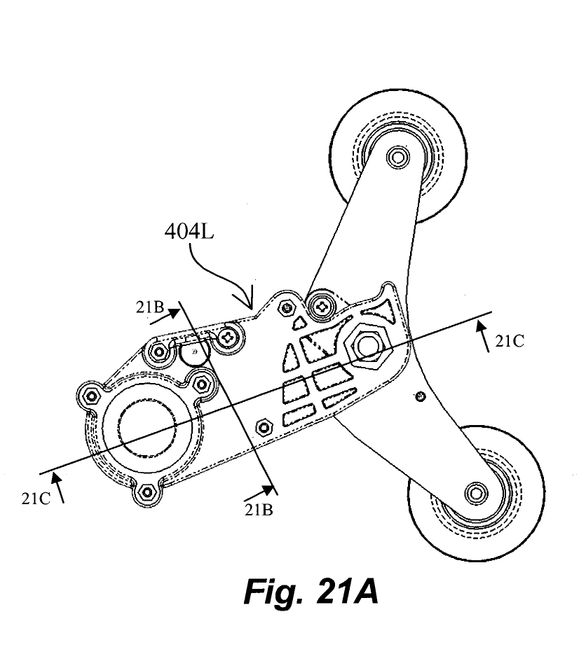

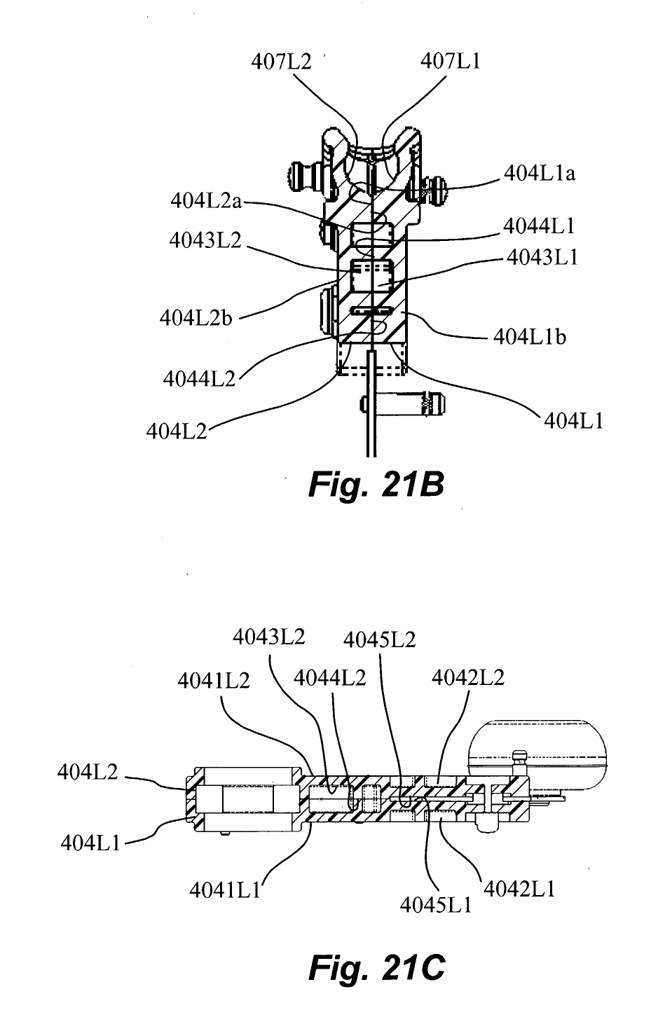

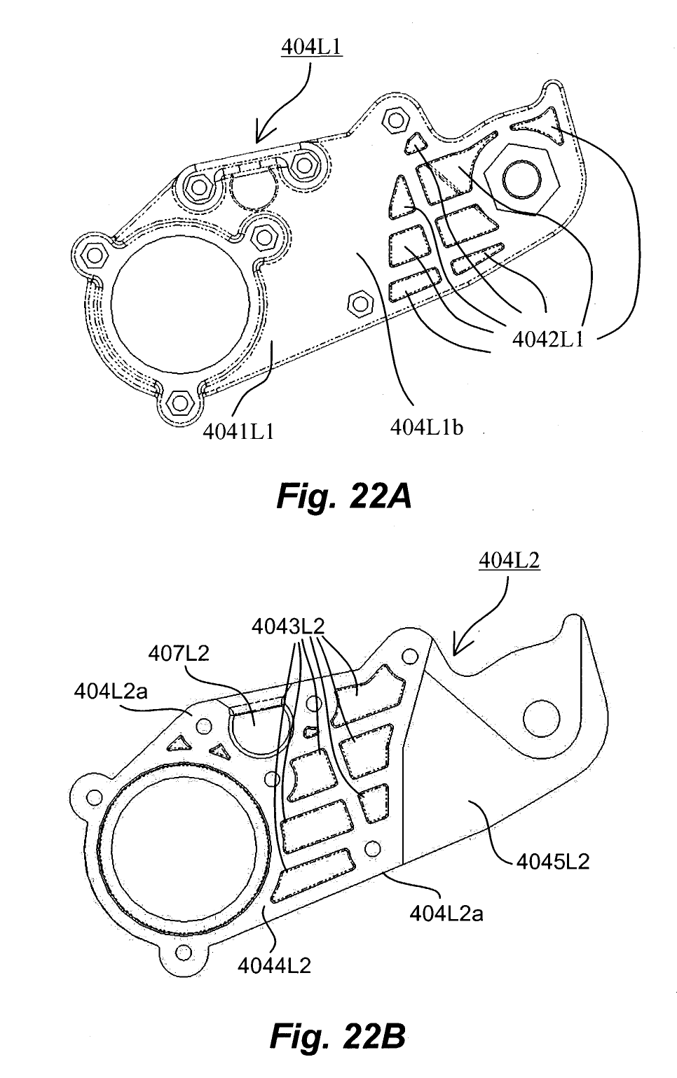

The structure of the left-hand arm supporter 404L for supporting a ball supporting arm 403 is described next more in detail with reference to FIGS. 21A, 21B and 21C (together referred to as FIG. 21). The right-hand arm supporter 404R is similarly structured and will not be repetitiously explained. As shown in FIG. 13 and explained above, this arm supporter 404L is formed with two sandwiching members 404L1 and 404L2 joined together. FIG. 22A shows an outer surface of one of these members 404L1 and FIG. 22B shows the contact surface of the other member 404L2.

The portions of the inner surfaces 404L1a and 404L2a of the arm supporter 404L near its base part 406 (on the left-hand side as seen in FIGS. 21 and 22) are made uneven with protrusions and indentations such that they contact each other only through their protruding parts. Their outer side surfaces 404L1b and 404L2b are flat (as shown in FIG. 21B). As shown in FIG. 22B, the inner surface 404L2a of the sandwiching member 404L2 has contacting surface parts 4044L2 which contact the oppositely disposed sandwiching member 404L1 and a plurality of indented parts 4043L2 which are made thinner by removing some of the material. As indicated in FIGS. 21B and 21C, similar contacting surface parts 4044L1 and indented parts 4043L1 are formed on the inner surface of the other sandwiching member 404L1. The contacting surface parts 4044L1 and 4044L2 of the two sandwiching members 404L1 and 404L2 protruding towards each other contact each other and the indented parts 4043L1 and 4043L2 do not contact each other.

A flat sliding area 4045L2 is also formed on the inner surface of the sandwiching member 404L2 towards the rotary shaft 408, as shown in FIG. 22B. This is an area for allowing the ball supporting arm 403L to slide on and is formed so as to be lower than that of the contacting surface part 4044L2. On the outer surface 404L1b of the other switching member 404L1, a flat part 4041L1 is formed in an area corresponding to the aforementioned indented part 4043L1 and a plurality of indented parts 4042L1 of the same height as the flat part 4041L1 are formed in an area corresponding to a slide area 4045L1.

As the pair of sandwiching members 404L1 and 404L2 thus formed are joined together to form the arm supporter 404L, their outer surfaces 404L1b and 404L2b are flat but their mutually oppositely facing inner surfaces 404L1a and 404L2a have mutually contacting protruding parts such that the structure has a higher rigidity than if they had flat contact surfaces and uneven outer surfaces. Thus, the arm supporters 404 according to the present invention are not deformed much under a load and the mutual displacement of contacting surfaces is reduced. As a result, creaking noise is less likely to be generated. Generation of such noise can be further suppressed by using different materials for the pair of sandwiching members 404R1 (and 404L1) and 404R2 (404L2).

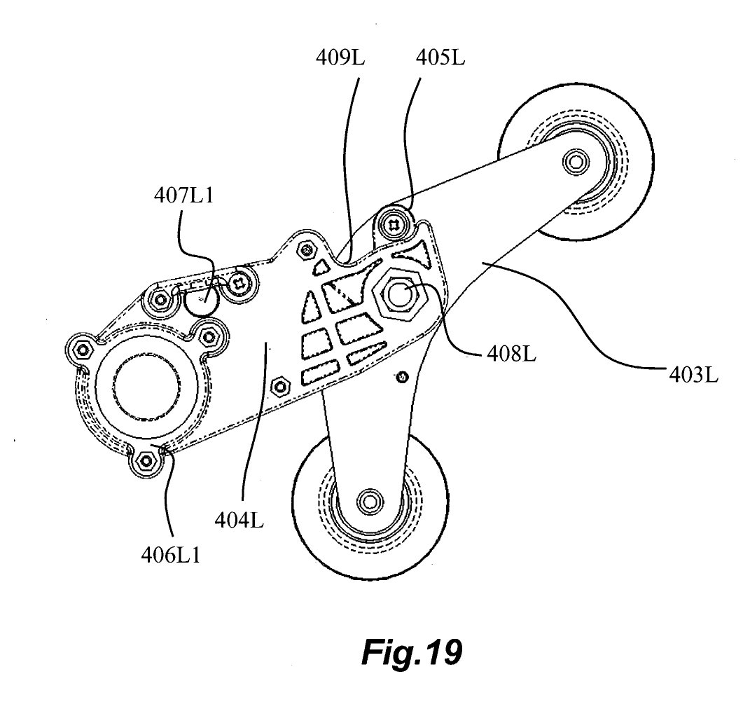

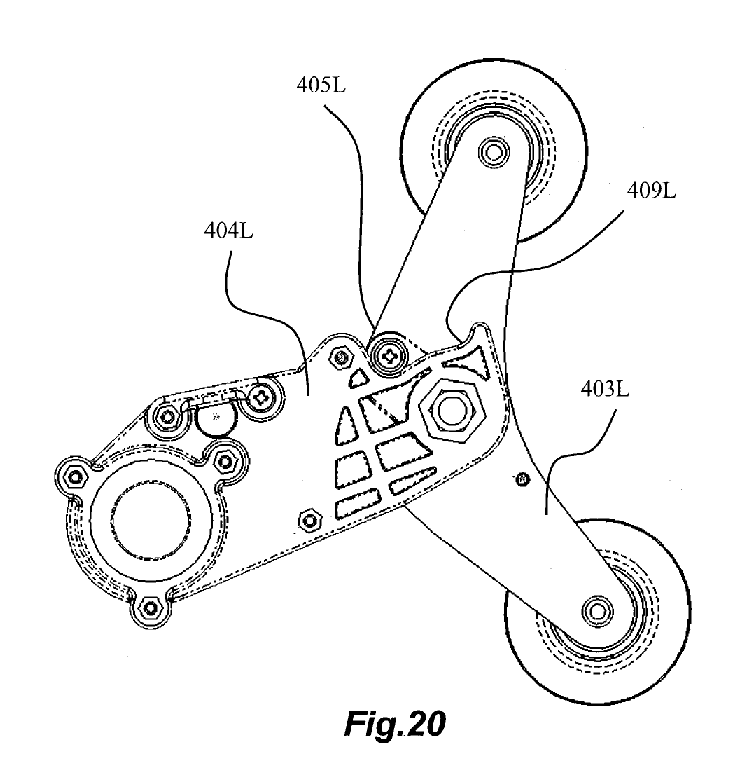

FIG. 19 shows a situation where the ball supporting arm 403L has rotated towards the back of the user and its stopper 405L has contacted the end part of a stopper receiver 409L towards the back of the user such that its rotation has been stopped. FIG. 20 shows another situation where the ball supporting arm 403L has rotated away from the back of the user and its stopper 405L has contacted the other end part of the stopper receiver 409L away from the back of the user such that its rotation has been stopped.

The arm supporters 404R (404R1 and 404R2) and 404L (404L1 and 404L2) are each provided with a stopper receiver 409R or 409L (the stopper 409R being structured similarly to the stopper 409L and not being shown) for receiving the stopper 405R or 405L. The portions of the stopper receivers 409R and 409L where the stopper 405R and 405L come into contact are in the same shape as that along the stoppers 405R and 405L. These stoppers 405R and 405L are cylindrically shaped and protrude perpendicularly to the direction in which the ball supporting arms 403R and 403L swing. The stopper receivers 409R and 409L are circularly arcuate according to the peripheral shape of the stoppers 405R and 405L such that the contact area therebetween is increased and the possibility of damage to the stoppers is diminished.

In FIGS. 13, 14 and 16, numeral 510 indicates another rotary shaft for the pounding operation, herein referred to as the “pounding shaft”, disposed above and parallel to the massaging shaft 410. On both right-hand and left-hand sides of the pounding shaft 510, at positions corresponding to those of the aforementioned sloped sleeves 420, eccentric parts 520 are formed, displaced radially in mutually opposite directions with respect to the pounding shaft 510. Bearing cases 521 (521R and 521L) are rotatably attached through bearings to the outer peripheries of the eccentric parts 520 so as to rotate over the peripheral surfaces.

As shown in FIGS. 9 and 11, the eccentric part 520 is provided with the bearing cases 521 (521R and 521L) which engage the outer periphery and link receivers 522 (522R and 522L) protruding peripherally. One end of the link 550 (550R and 550L) is connected to the arm supporter 404 (404R and 404L) as shown in FIG. 15, and the other end is supported so as to be movable in the axial direction of the pounding shaft 510 with respect to the link receiver 522 (522R and 522L) as shown in FIG. 11. The aforementioned arm supporters 404 (404R and 404L), the sloped sleeves 420 (420R and 420L), the base parts 406, the links 550 (550R and 550L), the eccentric parts 520 and the base parts 521 (521R and 521L) are hereinafter referred to as the “connecting means”.

With the connecting means thus formed, the spherically shaped end parts 551 of the links 550 are pushed as the user sits in the chair and his/her body weight is on the backrest and contact areas between the spherical end parts 551 of the links 550 and the link receivers 407 (407R (407R1 and 407R2) and 407L (or 407L1 and 407L2), only 407L being shown FIG. 19) increase so as to slow down the tears and wears of the contacting parts. Since a force is applied in the direction of compressing the links 550 while the machine is being used, the spherical parts 551 are not likely to become disengaged and hence components specifically for preventing the spherical end parts 551 from becoming disengaged can be dispensed with.

Next, the massaging mechanism of the treatment part 40 is explained. The massaging shaft 410 and the pounding shaft 510 are rotatably supported inside the ball supporting arms 403 (or 403R and 403L) by treatment shaft holders 601 (or 601R and 601L) which are affixed to a base member 401 by means of brackets 602 (or 602R and 602L) as shown in FIGS. 12-14. The treatment shaft holders 601 and the brackets 602 are hereinafter referred to as the “shaft holding means”. A motor 430 for the massaging operation (herein referred to as the “massaging motor”) is disposed perpendicularly to the base member 401 between the massaging shaft 410 and the pounding shaft 510, as shown in FIG. 16 and is detachably affixed to the treatment shaft holders 601 (or 601R and 601L) from the side opposite to the back of the user, as shown in FIG. 16.

A smaller pulley 411 is attached to the drive shaft 430a of the massaging motor 430. As shown in FIG. 16, an endless belt 413 is passed around this smaller pulley 411 and a larger pulley 412 attached to a worm gear 414. The worm gear 414 engages a worm wheel 415 which is coaxially secured over the outer periphery of the massaging shaft 410. The worm gear 414 and the worm wheel 415 which are parts of a power transmitting means are rotatably contained inside “treatment shaft holders” 601. Explained more in detail, the driving power of the massaging motor 430 is transmitted in turn through the smaller pulley 411, the belt 413, the larger pulley 412, the worm gear 414 and worm wheel 415 to rotate the massaging shaft 410.

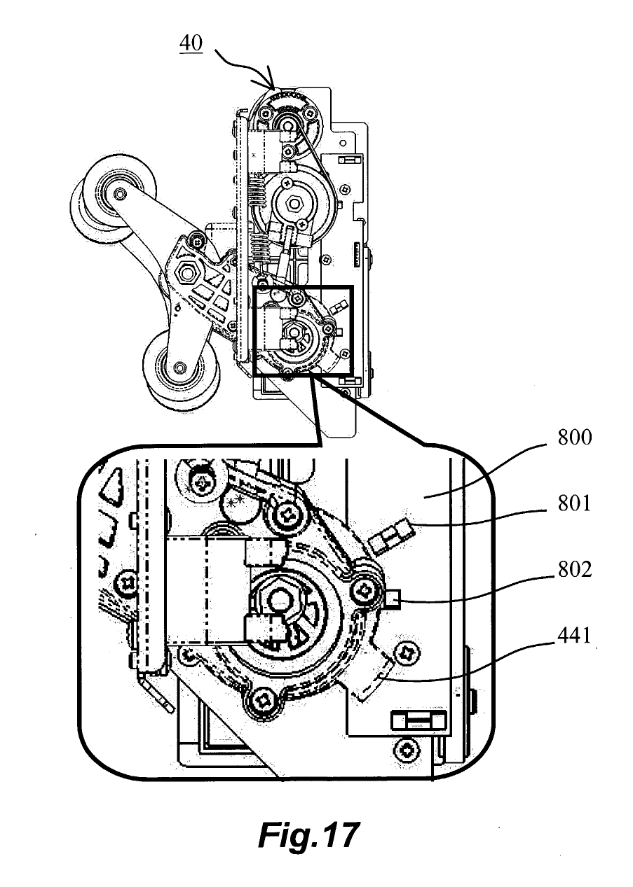

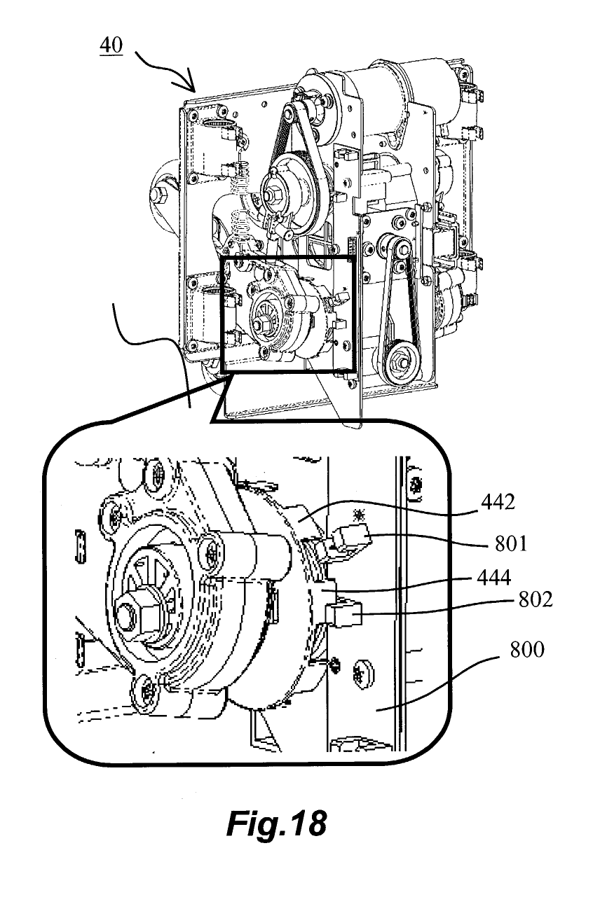

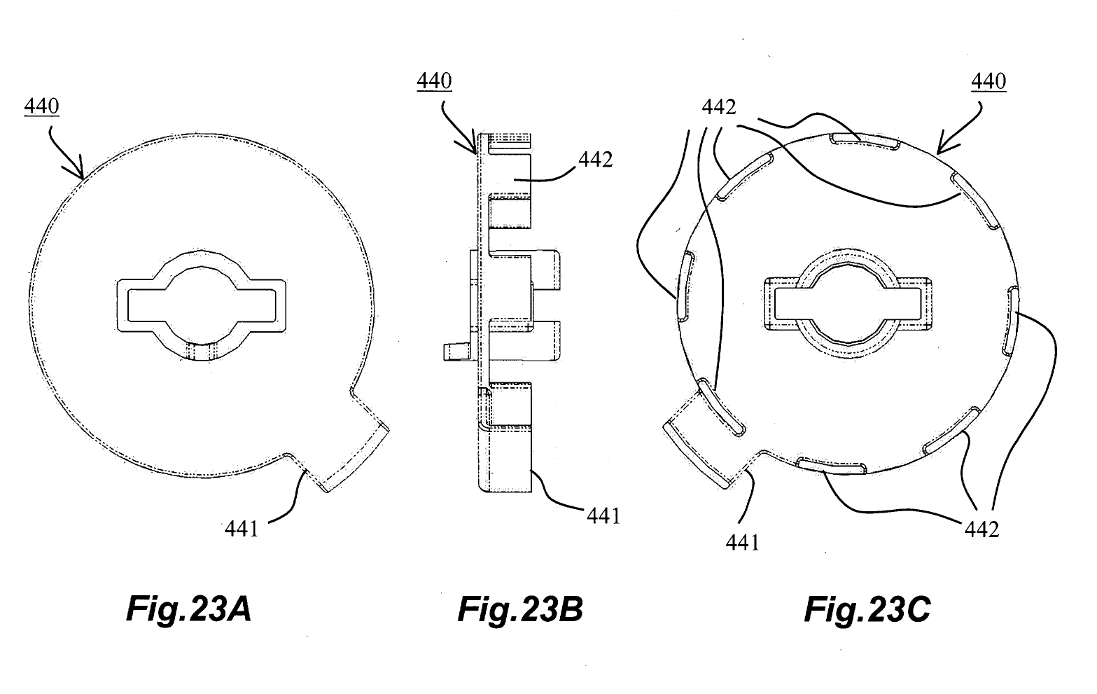

A detector 440 as shown in FIGS. 23A, 23B and 23C (together referred to as FIG. 23) for the rotary motion of the massaging shaft 410 is disposed coaxially therewith between the bracket 602R and the sloped sleeve 420R, as shown in FIG. 15. Both an origin-defining protrusion 441 as shown in FIG. 17 and pulse-detecting protrusions 442 as shown in FIG. 18 are integrally formed. The origin-defining protrusion 441 is for the detection of a reference angle for the massaging shaft 410. The pulse-detecting protrusions 442 are provided by dividing one rotation of the massaging shaft 410 into a plurality of equal angular intervals for detecting a relative angle with respect to the reference angle. The origin-defining and pulse-detecting protrusions 441 and 442 are formed on circles with different diameters and protrude in the axial direction of the massaging shaft 410, as shown in FIG. 23B.

The origin-defining and pulse-detecting protrusions 441 and 442 are detected respectively by sensors (origin-detecting sensor 801 and pulse detecting sensor 802) of a transmission type shown in FIGS. 17 and 18 on a detector PCB (printed circuit board) 800 disposed parallel to the surface of the bracket 602R. The sensor 801 is adjusted so as to detect the origin-defining protrusion 441 at the angle at which the gap between the massaging balls 402a and 402b becomes small. The pulse-detecting protrusions 442 may be prepared such that the detector 802 detects them when the gap between the massaging balls 402a and 402b is at the widest and at an intermediate width between the widest and the narrowest.

With the detector 440 thus formed, the massaging balls 402a and 402b are stopped when the gap therebetween is narrowed as the rotary motion of the massaging shaft 410 is stopped when the origin-defining protrusion 441 is detected by the origin-detecting sensor 801. As the pulse-detecting sensor 802 detects a pulse-detecting protrusion 442 after the origin-defining protrusion 441 is detected by the origin-detecting sensor 801, it can be determined whether the gap between the massaging balls 402a and 402b is wide or at an intermediate width. If the rotary motion of the massaging shaft 410 is stopped at this moment, the gap can be set accordingly. Alternatively, the rotary motion of the massaging shaft 410 can be varied by determining the gap between the massaging balls 402a and 402b. From the detection by the detector 440, presence or absence of the rotary motion can also be determined.

Next, the pounding mechanism of the treatment part 40 is explained. The pounding shaft 510 is driven by another motor 530 (the “pounding motor” shown in FIGS. 14 and 15) detachably affixed to the bracket of the treatment shaft holders 602R from the side opposite to the user's back and displaced to the right-hand side, as shown in FIG. 15. A smaller pulley 511 is attached to the drive shaft 530a of the pounding motor 530 and an endless belt 513 is passed over this smaller pulley 511 as well as a larger pulley 512 affixed coaxially to the outer periphery of the pounding shaft 510. Thus, the driving power of the pounding motor 530 is transmitted in turn through the smaller pulley 511, the belt 513 and the larger pulley 512, while being decelerated, and serves to rotate the pounding shaft 510. The smaller pulley 511, the belt 513 and the larger pulley 512 together form what is herein referred to as the decelerating power-transmitting means.

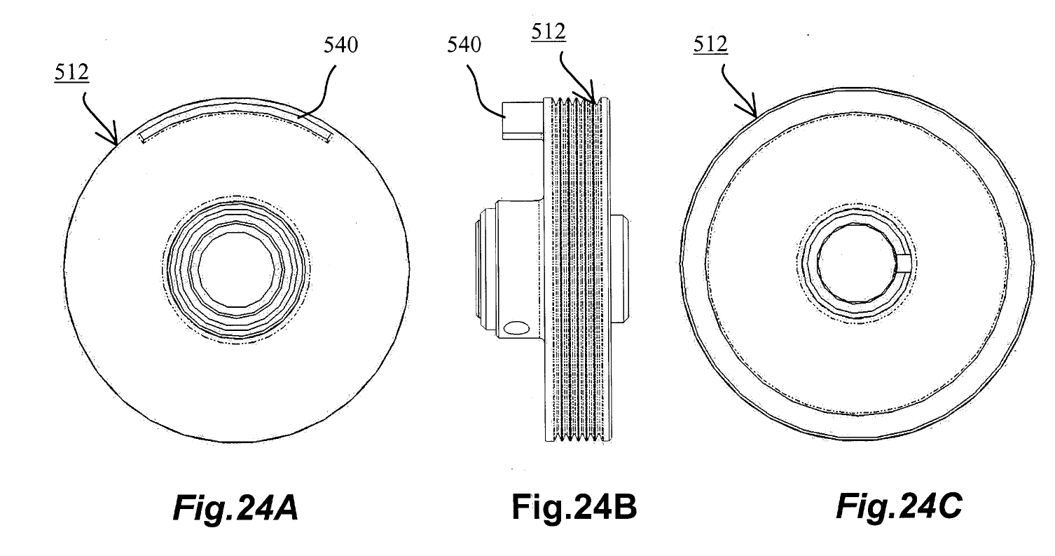

An arcuate position-indicating protrusion 540 is integrally formed in the axial direction on the outer periphery of the larger pulley 512, as shown in FIG. 24. It is detected by a sensor (“rotation sensor”) 803 disposed so as to sandwich the position-indicating protrusion 540, as shown in FIG. 15, for detecting the number of rotations of the pounding shaft 510. The rotation sensor 803 may be of a transmission type and disposed on the aforementioned detector PCB 800. The rotation sensor 803 can detect not only the presence or absence of the rotary motion but also the speed of rotation of the pounding shaft 510. Since the larger pulley 512 and the position-indicating protrusion 540 are integrally formed, the number of constituent components is limited and the production cost can be reduced.

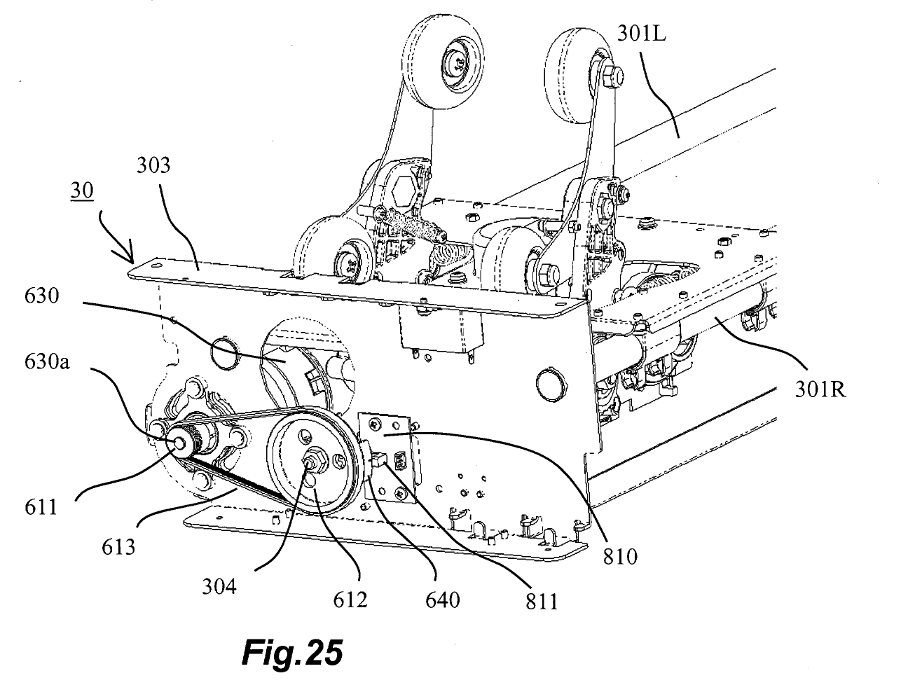

Next, the mechanism for moving the mobile treatment unit (the “lifting mechanism 30”) will be explained with reference mainly to FIG. 25.

As explained above, the lifting mechanism 30 includes a pair of guide pipes 301R and 301L (serving as guiding means) which are circular in cross-section and disposed along the backrest portion 10a, a screw shaft 304 disposed between and parallel to the two guide pipes 301R and 301L, and a pair of upper and lower guide pipe holders 302 and 303 which extend perpendicularly to the guide pipes 301R and 301L. As shown in FIGS. 5 and 13, lifting guides 306a, 306b, 306c and 306d are provided such that the treatment part 40 can slide axially along the guide pipes 301R and 301L and a nut 305 (the “lifting nut”) is provided to engage the outer periphery of the screw shaft 304.

The lifting nut 305 is supported by the aforementioned nut holder 701 which is affixed to the base member 401. The lifting guides 306a, 306b, 306c and 306d are also affixed to the base member 401.

The screw shaft 304 is driven by a motor (the “lifting motor”) 630 affixed to the lower guide pipe holder 303, as shown in FIG. 25. A smaller pulley 611 is attached to the drive shaft 630a of the lifting motor 630 and an endless belt 613 is passed around this smaller pulley 611 and the outer periphery of a larger pulley 612 such that the rotary power of the lifting motor 630 is transmitted in turn through the smaller pulley 611, the belt 613, the larger pulley 612 and the screw shaft 304 while being decelerated. As the screw shaft 304 is thus rotated, the nut 305 moves up or down.

The larger pulley 612 is provided with a position-indicating protrusion 640 (shown in FIG. 25) in its axial direction on its outer peripheral edge. A position sensor 811 of the transmission type is attached to a PCB 810 and is disposed so as to sandwich this protrusion 640 for detecting the number of rotations of the screw shaft 304 to which the larger pulley 612 is attached. Since the distance by which the nut 305 advances per rotation of the screw shaft 304 is known, the height of the treatment unit 40 along the guide pipes 301R and 301L can be detected by counting the number of rotations of the screw shaft 304. The position-indicating protrusion 640 and the position sensor 811 can also detect the presence and absence of rotation by the screw shaft 304. If the larger pulley 612 and the position-indicating protrusion 640 are formed integrally, the number of constituent parts can be limited and the production cost can be lowered.

The guide pipe holders 302 and 303 are respectively provided with an upper end indicator 307 and a lower end indicator 308, as shown in FIGS. 4, 5 and 7, for being detected by an upper limit sensor 812 and a lower limit sensor 813 (shown in FIG. 11) on the aforementioned detector PCB 800 attached to the treatment part 40 and thereby determining whether or not the treatment part 40 is at its upper limit position or lower limit position. The upper and lower end indicators 307 and 308 have cross-sectional shapes of a cross and the upper and lower limit sensors 812 and 813 are sensors of a transmission type, disposed so as to detect one end of the cross-shape of the upper and lower end indicators 307 and 308, respectively.

In summary, the detector PCB 800 supports thereon the origin-detecting sensor 801, the pulse detecting sensor 802, the rotation sensor 803, the upper limit sensor 812 and the lower limit sensor 813. The origin-detecting sensor 801, the pulse detecting sensor 802 and the rotation sensor 803 comprise what is herein also referred to as “rotary position detecting means” and the upper and lower limit sensors 812 and 813 comprise what is herein also referred to as “limit detecting means”. Since the rotary position and limit detecting means are both supported by a single PCB, the treatment part 40 can be structured compactly and its production cost can be reduced. Moreover, since the detector base plate 800 is affixed to one side surface of the treatment shaft holders 601R supporting the massaging motor 430 and the pounding motor 530, the cables for supplying power to these motors 430 and 530 and the signal lines from these sensors can be distributed together from a control box such that the assembly becomes easier and the cost of cables and signal lines can be reduced.

Although the structure according to this invention has been described above with reference to a preferred embodiment, this preferred embodiment is not intended to limit the scope of the invention. Appropriate modifications and variations are intended to be within the scope of this invention. Regarding the protrusions 540 and 640 from the larger pulleys 512 and 612 respectively for the pounding operation and lifting of the treatment part 40, they need not be in the axial direction but may be in the radial direction. Similarly, these protrusions need not be integrally formed but may be provided as separate components lighter than the pulleys. The sensors need not all be of a transmission type but may be of a reflective type, a micro-switch or a limit switch, depending on the convenience of assembling.

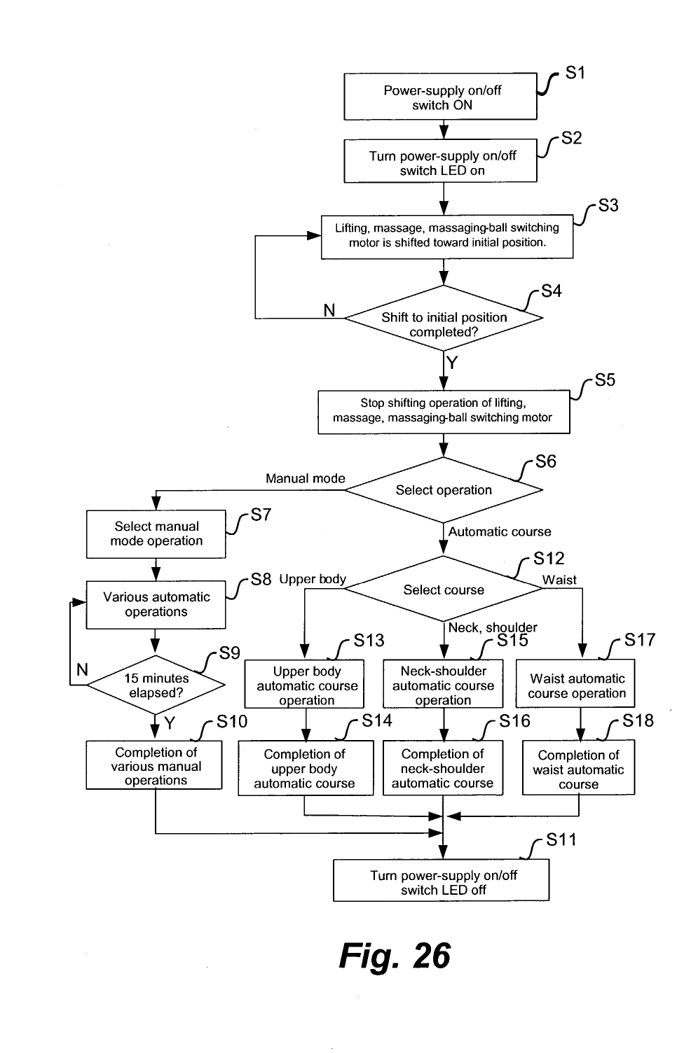

Operations of the massaging machine 1 are explained next with reference to FIGS. 26 and 27 in terms of commands outputted from a CPU control circuit 900 on the basis of instructions from the input device 910 and data from the sensors to a motor control circuit 901 to drive the motors and to display data on the input device 910.

As the power switch is switched on through the input device 910 (Step S1), an LED indicative of the condition of the power switch is lit to indicate that the power switch has been switched on (Step S2). Next, the lifting motor 630 and the massaging motor 430 are moved to their initial positions (Step S3). It continues to be monitored whether they have been moved to their initial positions (Step S4) until it is determined that they have reached their initial positions. When it is ascertained that they have reached their initial positions (YES in Step S4), their motion is stopped (Step S5).

Next, it is determined whether the manual mode or the automatic mode of operation has been selected (Step S6). If the manual mode is selected, it is determined which of the manual operations has been selected (Step S7) and the selected operation is carried out (Step S8). Operations that can be selected may include “massaging upward”, “massaging downward”, “pounding”, “back stretching”, “partial back stretching”, “up” and “down”. After the selected operation has been continued for 15 minutes (Step S9), the selected operation is stopped (Step S10) and the power switch is switch off (Step S11). The LED is accordingly switched off.

If the automatic mode is selected, it is determined which of the available automatic courses has been selected (Step S12). If the “upper body course” (an appropriate combination of back stretching, massaging and pounding operations over the entire upper body from the neck downwards by the shoulders and the back to the waist) is selected, for example, operations according to a corresponding menu are carried out (Step S13) and the control proceeds to Step S11 after the menu has been finished (Step S14). If the “neck and shoulder course” (an appropriate combination of back stretch, massaging and pounding operations over the parts from the neck to the shoulders) is selected, operations according to a menu corresponding to the course are carried out (Step S15) and the control proceeds to Step S11 after the menu has been finished (Step S16). If the “waist course” (an appropriate combination of back stretching, massaging and pounding operations near the waist) is selected, operations for the corresponding menu is carried out (Step S17) and the control proceeds to Step S11 after the menu has been finished (Step S18).

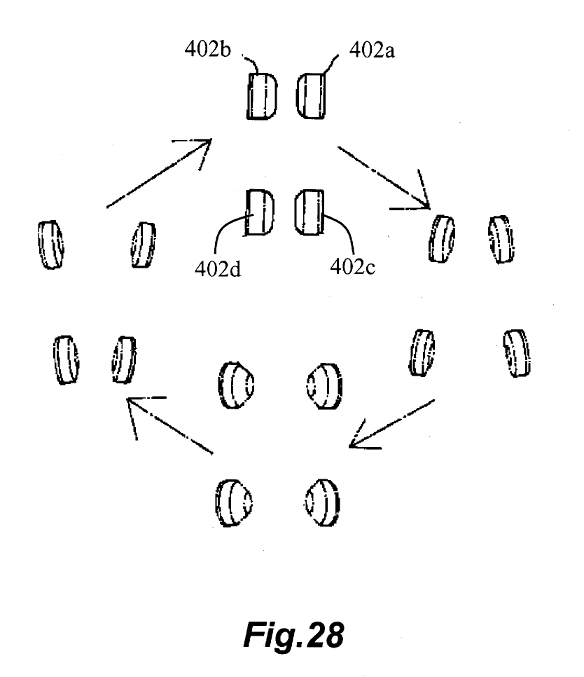

For the massaging operations, the rotary motion of the pounding shaft 510 is stopped and only the massaging shaft 410 is rotated. Since the ball supporting arms 403 (or 403R and 403L) are supported rotatably around the outer peripheries of the sloped sleeves 420 (or 420R and 420L) attached obliquely with respect to the massaging shaft 410 and the rotation around the massaging shaft 410 is limited through the links, the massaging balls 402a-d swing back and forth in the axial direction of the massaging shaft 410 while varying their distances from the axis or rotation of the massaging shaft 410, as shown in FIG. 28. The body of the user is thus massaged since the distance between massaging balls 402a-d on the right-hand and left-hand sides changes.

By changing the direction of rotation of the massaging motor 430, the direction of rotary motion of the massaging balls 403a-d can also be changed. In other words, the user can choose between “massaging upward” and “massaging downward”.

For effecting the pounding operation, the rotary motion of the massaging shaft 410 is stopped and the pounding shaft 510 is caused to rotate. Since the links 550R and 550L are rotatably supported by the eccentric parts 520 adapted to eccentrically rotate as the pounding shaft 510 is rotated, the distance between the axis of rotation of the pounding shaft 510 and the link receivers 407R and 407L engaged to ends of the links changes as the pounding shaft 510 is rotated. Since the ball supporting arms 403R and 403L are rotatably supported around the massaging shaft 410, they swing back and forth around the massaging shaft 410 as the pounding shaft 510 is rotated at an appropriate speed.

For the back stretch operation, both the massaging and pounding shafts 410 and 510 are stopped and the ball supporting arms 403R and 403L are maintained at the position of the origin while the lifting motor 630 is activated to cause the entirety of the massaging machine 1 to move up and down along the guide pipes 301R and 301L.

As can be understood from the descriptions given above, the present invention can provide a compact massaging machine.

What is claimed is:

1. A massaging machine comprising:
massaging balls;
a pair of ball supporting means for supporting said massaging balls;
two rotary shafts for driving said ball supporting means and thereby causing said massaging balls to undergo two different treatment actions;
a single shaft holder for holding said two rotary shafts parallel to each other;
connecting means connected to both end parts of said two shafts for connecting and operating together said two shafts and said ball supporting means;
motors for operating said two shafts independently; and
motion communicating means for communicating driving power of said motors to said two rotary shafts;
wherein said shaft holder is disposed entirely between said pair of ball supporting means and includes motor supports that support said motors.

2. The massaging machine of claim 1 wherein at least one of said motion communicating means is disposed inside said shaft holder and wherein said one motion communicating means and the motor of which the driving power is communicated by said one motion communicating means are disposed opposite each other with respect to the rotary shaft driven through said one motion communicating means.

3. The massaging machine of claim 2 wherein said motors are disposed between said two rotary shafts and approximately perpendicular to each other.

4. The massaging machine of claim 3 wherein said motors are supported by said shaft holder so as to be removably attachable from a direction facing the back of the user and another direction opposite thereto.

5. The massaging machine of claim 1 wherein at least one of said motors is supported by said shaft holder approximately parallel and adjacent to said rotary shafts.

6. The massaging machine of claim 5 wherein said motors are supported by said shaft holder so as to be each removably attachable from a direction of a different one of said two rotary shafts.

7. The massaging machine of claim 1 wherein said massaging balls, said ball supporting means, said rotary shafts, said shaft holder, said connecting means, said motors and said motion communicating means together comprise a treatment unit that is movable with respect to the user.

8. The massaging machine of claim 2 wherein said massaging balls, said ball supporting means, said rotary shafts, said shaft holder, said connecting means, said motors and said motion communicating means together comprise a treatment unit that is movable with respect to the user.

9. The massaging machine of claim 3 wherein said massaging balls, said ball supporting means, said rotary shafts, said shaft holder, said connecting means, said motors and said motion communicating means together comprise a treatment unit that is movable with respect to the user.

10. The massaging machine of claim 4 wherein said massaging balls, said ball supporting means, said rotary shafts, said shaft holder, said connecting means, said motors and said motion communicating means together comprise a treatment unit that is movable with respect to the user.

11. The massaging machine of claim 5 wherein said massaging balls, said ball supporting means, said rotary shafts, said shaft holder, said connecting means, said motors and said motion communicating means together comprise a treatment unit that is movable with respect to the user.

12. The massaging machine of claim 6 wherein said massaging balls, said ball supporting means, said rotary shafts, said shaft holder, said connecting means, said motors and said motion communicating means together comprise a treatment unit that is movable with respect to the user.

13. The massaging machine of claim 7 further comprising position detectors for detecting angular positions of said two rotary shafts and limit sensors for detecting limit positions of said treatment unit, said shaft holder including support members supporting said position detectors and said limit sensors.

14. The massaging machine of claim 8 further comprising position detectors for detecting angular positions of said two rotary shafts and limit sensors for detecting limit positions of said treatment unit, said shaft holder including support members supporting said position detectors and said limit sensors.

15. The massaging machine of claim 9 further comprising position detectors for detecting angular positions of said two rotary shafts and limit sensors for detecting limit positions of said treatment unit, said shaft holder including support members supporting said position detectors and said limit sensors.

16. The massaging machine of claim 10 further comprising position detectors for detecting angular positions of said two rotary shafts and limit sensors for detecting limit positions of said treatment unit, said shaft holder including support members supporting said position detectors and said limit sensors.

17. The massaging machine of claim 11 further comprising position detectors for detecting angular positions of said two rotary shafts and limit sensors for detecting limit positions of said treatment unit, said shaft holder including support members supporting said position detectors and said limit sensors.

18. The massaging machine of claim 12 further comprising position detectors for detecting angular positions of said two rotary shafts and limit sensors for detecting limit positions of said treatment unit, said shaft holder including support members supporting said position detectors and said limit sensors.

19. The massaging machine of claim 7 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

20. The massaging machine of claim 8 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

21. The massaging machine of claim 9 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

22. The massaging machine of claim 10 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

23. The massaging machine of claim 11 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

24. The massaging machine of claim 12 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

25. The massaging machine of claim 13 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

26. The massaging machine of claim 14 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

27. The massaging machine of claim 15 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

28. The massaging machine of claim 16 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

29. The massaging machine of claim 17 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.

30. The massaging machine of claim 18 further comprising two guide members for guiding said treatment unit and a control circuit for controlling said massaging machine, said guide members being disposed on mutually opposite external sides of lines extended along said two rotary shafts, said control circuit being disposed further outside of one of said guide members with respect to said two rotary shafts.
